(19) United States
(12) Patent Application Publication
(10) Pub. No.: US 2026/0161707 A1
(43) Pub. Date: Jun. 11, 2026

(54) TRAINING DATA PROCESSING FOR LARGE LANGUAGE MODELS

(71) Applicant: Red Hat, Inc., Raleigh, NC (US)

(72) Inventors: Anna Luti, Milan (IT); Paolo Antinori, Milan (IT)

(21) Appl. No.: 18/977,639

(22) Filed: Dec. 11, 2024

(51) Int. Cl. G06F 16/901; G06F 16/25; G06N 3/0475

(52) U.S. Cl. CPC G06F 16/9024; G06F 16/258; G06N 3/0475

(57) ABSTRACT

A method, a system, and a non-transitory computer-readable medium are provided. The method includes extracting a plurality of references from a plurality of data items received from a plurality of data sources. The method includes generating, by the processing device, a data structure comprising a plurality of nodes and a plurality of edges. The plurality of nodes are respectively associated with the plurality of data sources, and the plurality of edges are respectively associated with the plurality of references. The method includes determining, based on the data structure, a plurality of scores respectively associated with the plurality of data sources. The method includes generating a training dataset for training a large language model (LLM) based on the plurality of data items and the plurality of scores.

### TECHNICAL FIELD

Aspects of the present disclosure relate to training large language models (LLMs) and more particularly, to processing training data for LLMs.

### BACKGROUND

Applications based on generative artificial intelligence (AI) may deploy LLMs to process user inputs, e.g., search queries or chat messages, in human language and return a response accordingly. The quality of the response is often dependent on the quality of the training dataset of the LLMs.

### BRIEF DESCRIPTION OF THE DRAWINGS

The described implementations and the advantages thereof may best be understood by reference to the following description taken in conjunction with the accompanying drawings. These drawings in no way limit any changes in form and detail that may be made to the described implementations without departing from the spirit and scope of the disclosure.

FIG. 1A is a block diagram that illustrates a system for training a LLM for an AI-related application, according to some implementations.

FIG. 1B is a block diagram that illustrates a system for training a LLM for an AI-related application, according to some implementations.

FIG. 2A is a graph that illustrates a data structure for training data processing, according to some implementations.

FIG. 2B is a graph that illustrates an updated data structure for training data processing, according to some implementations.

FIG. 3 is a flowchart that illustrates a method for training data processing, according to some implementations.

FIG. 4 is a block diagram of an example apparatus that may perform one or more of the operations described herein, according to some implementations.

### DETAILED DESCRIPTION

In semantic search and other generative AI-related applications, a client device (e.g., a mobile device or a personal computer) may instruct an application to generate a response based on user inputs in human language. It is generally desirable for the application to be able to generate a high quality response, e.g., a response that properly follows the instruction, provides insightful and accurate information, and conveys the information in a comprehensible and intelligent manner. To meet these needs, many applications use machine learning, which deploys LLMs (e.g., neural networks) to help a machine (e.g., an AI server or an AI edge device) interpret the prompt and infer a response. With the progress of LLM technologies, LLM-based machine learning has been rapidly adopted in many fields, such as media, business, legal, and academia, to perform tasks that previously either required excessive human effort or could not be practically accomplished by human using generic computing tools.

A factor that affects the response quality of a LLM is the training datasets. To provide a high quality response, it is desirable for a LLM to use high quality training data, e.g., data with high relevance, accuracy, and reliability. However, because many LLMs are trained using data from publicly available sources, such as internet websites, with no or little discrimination, it is often difficult to control the quality of the training data. This difficulty often leads to decreased explainability of a machine learning model in the AI-related application.

In view of the above challenges, implementations of this disclosure provide a mechanism to process data from various data sources and selectively feed the training data to a LLM. In particular, implementations of this disclosure provide a data structure capable of indicating the quality of each training data source such that the LLM may weigh each data source separately according to the quality of each individual data source. According to some implementations, a system or an apparatus extracts a plurality of references from a plurality of data items received from a plurality of data sources. A processing device generates a data structure including a plurality of nodes and a plurality of edges. The plurality of nodes are respectively associated with the plurality of data sources, and the plurality of edges are respectively associated with the plurality of references. The system or the apparatus determines, based on the data structure, a plurality of scores respectively associated with the plurality of data sources. The system or the apparatus generates a training dataset for training a LLM based on the plurality of data items and a plurality of scores. With one or more features described below in detail, implementations of this disclosure advantageously improve the quality of training data of LLMs, improve the reliability of AI-related applications, and thereby improve the productivity in many industries.

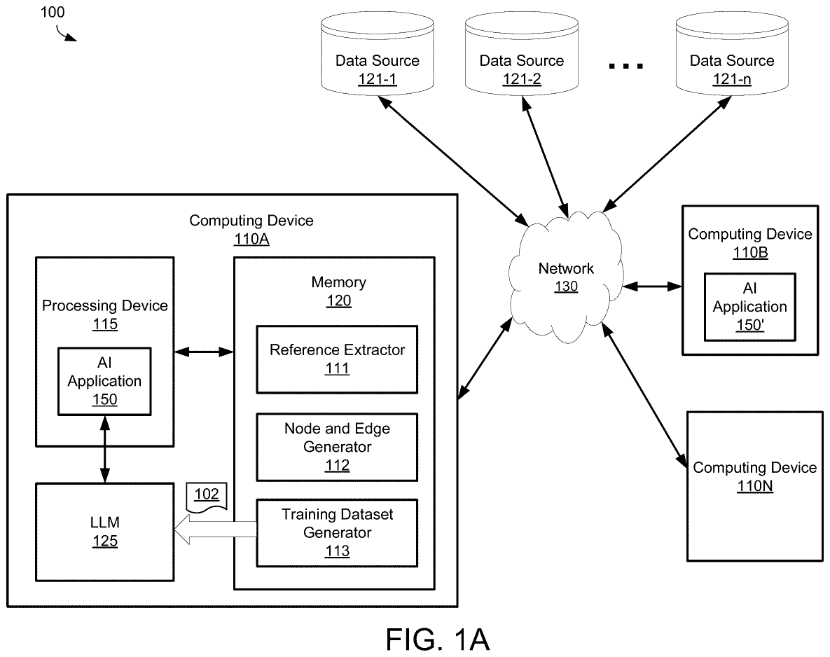

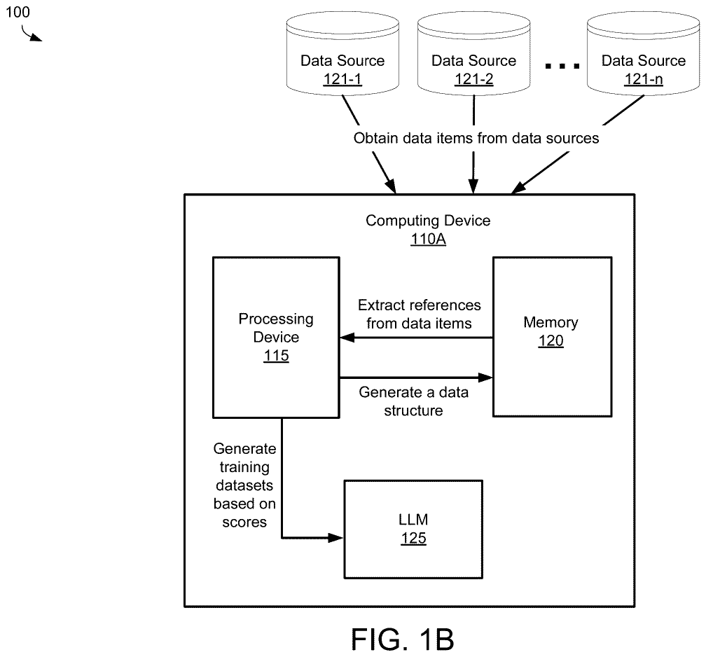

FIGS. 1A and 1B are block diagrams that illustrate an example system 100 for training a LLM for an AI-related application, according to some implementations. Other systems are possible, and implementations of a system utilizing examples of the disclosure are not necessarily limited to the specific architecture depicted by FIGS. 1A and 1B.

As illustrated in FIG. 1A, system 100 includes computing devices 110A, 110B, . . . 110N (collectively referred to as computing devices 110), and a network 130. Computing devices 110 may be coupled to each other (e.g., may be operatively coupled, communicatively coupled, may communicate data/messages with each other) via network 130. Network 130 may be a public network (e.g., the internet), a private network (e.g., a local area network (LAN) or wide area network (WAN)), or a combination thereof. In some implementations, network 130 may include a wired or a wireless infrastructure, which may be provided by one or more wireless communications systems, such as a WiFi™ hotspot connected the network 130 and/or a wireless carrier system that can be implemented using various data processing equipment, communication towers (e.g., cell towers), etc. Network 130 may carry communications (e.g., data, message, packets, frames, etc.) between computing devices 110. Each of computing devices 110 may include hardware such as processing device 115 (e.g., processors, central processing units (CPUs), memory 120 (e.g., random access memory (RAM), storage devices (e.g., hard-disk drive (HDD), solid-state drive (SSD), etc.), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

FIGS. 1A, 1B, and the other figures may use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral.

Each of computing devices 110 may comprise any suitable type of computing device or machine that has a programmable processor including, for example, server computers, desktop computers, laptop computers, tablet computers, smartphones, set-top boxes, etc. In some examples, computing devices 110 may comprise a single machine or may include multiple interconnected machines (e.g., multiple servers configured in a cluster). Computing devices 110 may be implemented by a common entity/organization or may be implemented by different entities/organizations. For example, computing device 110A may be operated by a first company/corporation and computing device 110B may be operated by a second company/corporation. Computing devices 110 may each execute or include an operating system (OS), as discussed in more detail below. The OSs of each of computing devices 110 may manage the execution of other components (e.g., software, applications, etc.) and/or may manage access to the hardware (e.g., processors, memory, storage devices etc.) of their respective computing device. In some implementations, a client device is implemented to have similar functions and a similar structure as some of computing devices 110, such as computing device 110B.

As shown in FIG. 1A, computing device 110A, particularly processing device 115, is in communication with a plurality of data sources 121-1, 121-2, . . . , 121-n (collectively referred to as data sources 121) via network 130. Network 130 may be a public network (e.g., the internet), a private network (e.g., a local area network (LAN) or wide area network (WAN)), or a combination thereof. In some implementations, network 130 includes a wired or a wireless infrastructure, which may be provided by one or more wireless communications systems, such as a WiFi™ hotspot connected with the network 130 and/or a wireless carrier system that can be implemented using various data processing equipment, communication towers (e.g., cell towers), etc. Network 130 may carry communications (e.g., data, message, packets, frames, etc.) between computing devices 110. Each of data sources 121 may be a mobile terminal or a computing device similar to any of computing devices 110 that stores data. In some implementations, network 130 is the Internet and data sources 121 are website servers accessible from the Internet, such as servers for academic literature, news media, encyclopedia, social media, streaming platforms, discussion boards, etc. Data sources 121 store data items in a variety of media formats (e.g., text, photo, video, audio, etc.) that processing device 115 may access through network 130. In some implementations where processing device 115 is configured to provide training data for a generative AI application, processing device 115 may select data sources 121 from a pool of candidate data sources, such as a superset of data sources 121, based on the topic or context of the generative AI application.

Processing device 115 may be implemented as one or more processors in a computing system configured to execute program instructions, e.g., for providing training datasets to train LLM 125 for AI application 150. As illustrated, processing device 115 may execute reference extractor 111, node and edge generator 112, and training dataset generator 113, each of which may be implemented as software instructions stored in memory 120. Processing device 115 may also execute AI application 150 by deploying LLM 125. In some implementations, execution of AI application 150 involves execution of a corresponding edge-side AI application on the client device, such as AI application 150′ on computing device 110B. For example, a user of computing device 110B may provide a query a query to AI application 150′, which forwards the query to AI application 150 for processing.

Referring to FIGS. 1A and 1B, the processing device 115 uses reference extractor 111 to extract references from data items, which may represent raw (e.g., unprocessed or unevaluated) content stored on data sources 121. In some implementations, processing device 115 obtains data items from data sources 121 over network 130 and extracts references from the data items to indicate links between data sources 121. Each link may be a semantic or logical link that connects two data sources to indicate a semantic or logical relationship between the two data sources as pertaining to a topic or context. For example, processing device 115 may obtain a video clip of a movie from a streaming website (data source A) and obtain an article discussing the cast of the movie from an online entertainment forum (data source B). Based on the content of the video clip and the content of the article, reference extractor 111 may identify a link between data sources A and B to indicate that data items in data source B “discuss” data items in data source A. Reference extractor 111 may thus extract a reference “discuss” to indicate the link. As another example, processing device 115 may obtain a catalog of merchandise from an online merchant's website (data source C) and obtain a photo of some items sold by the merchant from a customer review platform (data source D). Based on these contents, reference extractor 111 may identify a link between data sources C and D to indicate that data items in data source D “review” data items in data source C. Reference extractor 111 may thus extract a reference “review” to indicate the link. The links described herein may be unidirectional, e.g., from one data source to another data source, or bidirectional, e.g., connecting data sources without specifying a direction. It is possible that the same data source is connected to multiple other data sources via multiple links. For example, a data source of a car dealer's website may be linked to a data source of a car manufacturer's website with the reference “retail,” to a data source of local news publisher with the reference “advertisement,” to another data source of an online mechanical engineering forum with the reference “design,” and to another data source of an online dictionary with the reference “define.”

The data items from different data sources 121 may be in different media formats. Also, the same data item from a single data source may have content in multiple media formats. For example, one data source may provide data items in pure text, while another data source may provide data items in video clips with sound, images, and text embedded therein. To extract references from these data items, reference extractor 111 may first detect the media format of each item, e.g., based on the compression format of a data file. Reference extractor 111 may then select a media conversion application according to the detected media format and deploy the media conversion application to convert the media format to a different, desired media format. For example, reference extractor 111 may select a speech-to-text application upon detecting a data item is in the audio format, and may select an optical character recognition (OCR) application upon detecting a data item is in the image format or infographic format. Other example media conversion applications include: regex patterns for text, natural language processing (NLP) and named entity recognition (NER) for text, web scraping HTML parsing to parse web content (e.g., content using libraries such as BeautifulSoup) and extract hyperlinks and citations, image annotation and analysis for image metadata, metadata extraction for structured documents (e.g., .pdf or .docx), etc. The ability to extract references in different media formats from the same data item improves the accuracy of data source scoring and training dataset selection, which are described later in this disclosure.

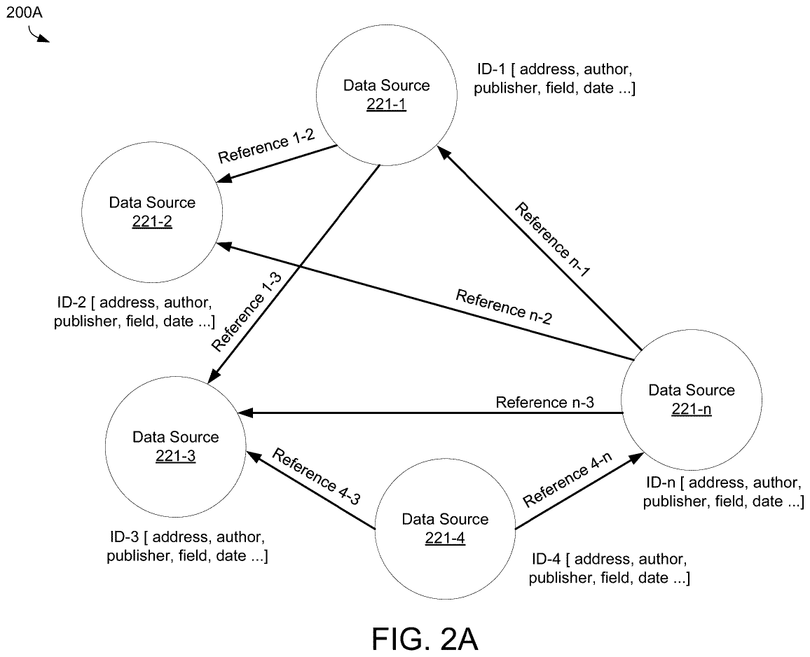

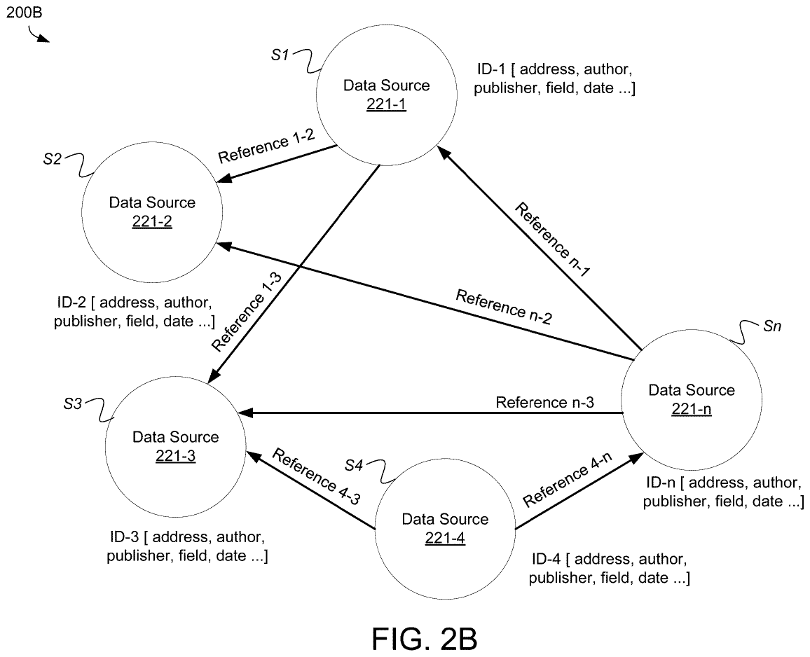

Processing device 115 uses node and edge generator 112 to generate a data structure (shown in FIGS. 2A and 2B) that represents the output of reference extractor 111. The data structure includes a plurality of nodes to represent data sources 121. To identify each data source in the data structure, each node may include one or more fields to indicate metadata, such as the address, author, publisher, field, publication date, and/or other information, of the data source. Processing device 115 obtains such information when selecting data sources 121 from a pool of data sources, or obtains such information based on the extraction by reference extractor 111. With the metadata included in the data structure, the data items in data sources 121 are augmented from the raw content.

The data structure also includes a plurality of edges to represent the links generated by reference extractor 111. For example, when two data sources are linked, node and edge generator 112 generates an edge between the nodes representing the two data sources. Each edge may include a field for the starting node and a field for the destinate node (in the case of unidirectional links) or two fields for the two nodes of the link (in the case of bidirectional links). Each edge may further include a field to indicate the reference extracted by reference extractor 111.

In such a data structure with nodes and edges, the number of edges (which corresponds to the number of links) in connection with a particular node generally suggests the level of relevance of the particular node to the topic or context of interest. For example, the higher number of edges, the higher level of relevance the particular node is likely to the topic or context.

After generating the data structure, processing device 115 updates the data structure to account for other factors that may affect the quality of a training dataset. These factors include, e.g., the authority and trustworthiness of a data source, the recency of the data content in the data source, and the relevance of the data source to the topic of the AI application. For example, a data source associated with a reputable research institution may provide higher quality training data on a scientific topic than a data source associated with a tabloid magazine. Similarly, a more recent data source on a sports team may provide higher quality training data on the standing of the team in an ongoing tournament than a data source ten years ago. Also, a data source associated with Country A's government may provide higher quality training data for an AI application targeting Country A's population than a data source associated with Country B's government. In general, these factors qualitatively or quantitively indicate the reliability of a data source.

To account for these factors, processing device 115 may determine a score for each data source. For each factor, processing device 115 may assign a value to the data source to quantify the factor for the data source. As an example, on a scale of −5 to 5 and for training a LLM on a scientific topic, processing device 115 may assign “4” to a data source associated with a reputable research institution and assign “−2” to a data source associated with a tabloid magazine known to spread misinformation. The values in this example are associated with the “authority and trustworthiness” factor. As another example, on a scale of 1 to 5 and for training a LLM for an AI application targeting Country A's population, processing device 115 may assign “5” to a data source associated with Country A's government and assign “3” to a data source associated with Country B's government. The values in this example are associated with the “relevance of the data source to the topic of the AI application” factor. Depending on the topic or context of interest, the same data source may be assigned different values even for the same factor. The values assigned to the factors may be collectively referred to as reliability information.

Processing device 115 determines the score associated with each node by calculating a weighted sum of the assigned values. The weighted sum may also include the number of edges. For example, assuming a node associated with a data source is connected to N edges, and the values assigned to the data source for three factors are X, Y, and Z, respectively, then processing device 115 may calculate the score S=w1×N+w2×X+w3×Y+w4×Z, where w1 to w3 are weights for the three factors. In general, the weights for the factors in the calculation of a score may be specified by processing device 115 or an external source according to AI application 150. The weights may be positive or negative, depending on the topic or context of interest. After calculating the scores for all data sources 121, processing device 115 may further normalize the scores across all data sources 121 to ensure consistency. In some alternative implementations, an external processing device may calculate the scores for data sources 121 and store the scores in a database. In this case, processing device 115 does not need to calculate the scores but may instead retrieve the stores scores from the database.

Processing device 115 may use training dataset generator 113 to generate training datasets for LLM 125 based on the scores of data sources 121. In some implementations, training dataset generator 113 compares the score associated with each data source with a threshold score. If the score of a data source does not satisfy the threshold, training dataset generator 113 eliminates that data source from suppliers of training datasets. This way, LLM 125 may be free from the influence of training datasets from data source of very low quality.

Alternatively or additionally, training dataset generator 113 obtains training datasets from data sources 121 based on a weighted sampling, with the sampling weights of the data sources correlating to the respective scores. For example, training dataset generator 113 randomly samples among data sources 121 to obtain training datasets, and the probability of sampling from a particular data source correlates to the score associated with the particular data source. In other words, the higher the score of a particular data source, the higher probability the particular data source is sampled to provide training datasets. Because the score of a data source indicates the quality of training datasets, high quality data sources are likely to have greater influence on the training dataset received by LLM 125. Example weighted sampling algorithms include “numpy.random.choice” and reservoir sampling.

With the operations of reference extractor 111, node and edge generator 112, and training dataset generator 113, processing device 115 provides training dataset 102 to LLM 125. During the execution of AI application 150, a client device may query AI application 150 about a semantic topic (e.g., a topic with a semantic meaning or expressed in a semantic manner). In response, processing device 115 may deploy AI application 150 to generate a response to the query based on LLM 125. Because of the improved quality of the training datasets of LLM 125, AI application 150 may have improved explainability and provide improved user experience.

In some implementations, processing device 115 may fine-tune the generated training datasets by, e.g., adjusting the scores of data sources 121, adjusting the weights in weighted sampling, or adding or removing data sources. The fine-tuning operations may be supervised, e.g., with a human operator reviewing the training datasets and/or the response generated by AI application 150. The fine-tuning operations may also be unsupervised, e.g., with another system or application automatically making training adjustments without human involvement. Processing device 115 may perform the fine-tuning operations during the training of LLM 125 or during the deployment of AI application 150.

FIG. 2A is a graph that illustrates a data structure 200A for training data processing, according to some implementations. Data structure 200A may be generated by node and edge generator 112 of FIG. 1 and stored in a computer-readable medium.

As illustrated, data structure 200A has a plurality of nodes (shown as circles) associated with data sources 221-1, 221-2, . . . , 221-n (collectively referred to as data sources 221), which may be similar to data sources 121 of FIG. 1. The nodes each have an identifier, ID-1, ID-2, . . . ID-n, respectively, which includes one or more metadata fields for, e.g., address, author, publisher, field, date, etc.

Data structure 200A also has a plurality of edges (shown as arrowed lines) that link the plurality of nodes and correspond to a plurality of references. For example, reference 1-2 is associated with an edge that links the nodes for data sources 221-1 and 221-2, reference n-3 is associated with an edge that links the nodes for data sources 221-n and 221-3, and so forth. The references may be extracted by reference extractor 111 of FIG. 1.

FIG. 2B is a graph that illustrates an updated data structure 200B for training data processing, according to some implementations. Data structure 200B is updated based on data structure 200A of FIG. 2A.

As illustrated, data structure 200B is updated from data structure 200A to reflect the scores S1, S2, . . . Sn, for data sources 221. For example, the nodes associated with data sources 221 may each expand its fields to include an additional field for the associated score. After the update, data structure 200B may be stored in a computer-readable medium, which may or may not be the same medium where data structure 200A is stored. A training dataset generator, such as training dataset generator 113 of FIG. 1, may thus access the computer-readable medium to retrieve data structure 200B and generate training datasets for a LLM.

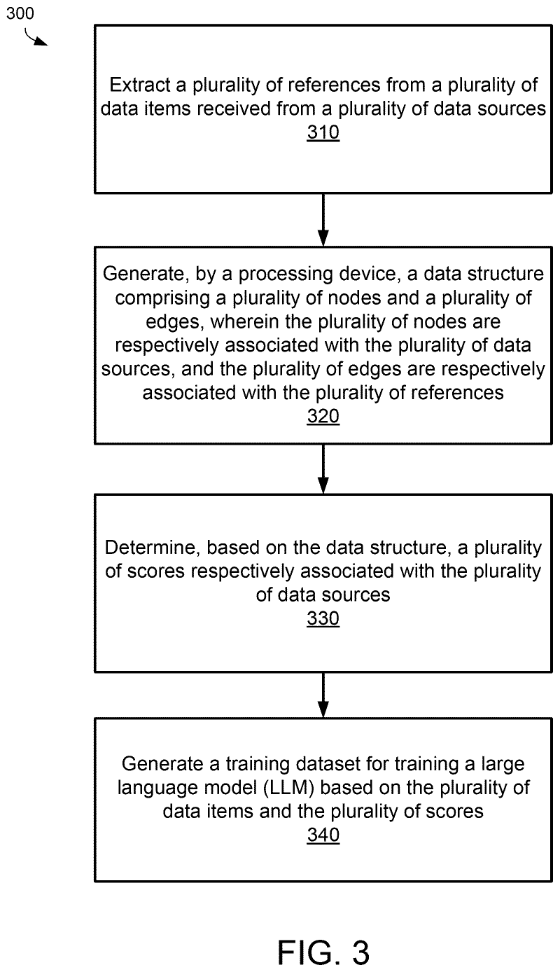

FIG. 3 is a flowchart that illustrates an example method 300 for training data processing, according to some implementations. Method 300 may be performed by a computing apparatus or a computing system, such as system 100 of FIG. 1. The illustration of method 300 in a flowchart does not necessarily mean that the operations of method 300 are performed in a chronological order. In some implementations, method 300 contemplates performing some operations in series, in parallel, or in a different order than the illustrated order. For example, it is possible that operations at 320 and 330 may be performed concurrently.

At 310, method 300 involves extracting a plurality of references from a plurality of data items received from a plurality of data sources, such as data sources 121 of FIG. 1 or data sources 221 of FIGS. 2A and 2B. The references may be similar to those illustrated in FIG. 2A, which indicate semantic or logical links between data sources. In some implementations, the extraction involves deploying a media conversion application to convert the media format of a data item.

At 320, method 300 involves generating, by a processing device, a data structure comprising a plurality of nodes and a plurality of edges. The plurality of nodes are respectively associated with the plurality of data sources, and the plurality of edges are respectively associated with the plurality of references. In the data structure, each node may be associated with an identifier of a corresponding data source, such as that illustrated in FIGS. 2A and 2B.

At 330, method 300 involves determining, based on the data structure, a plurality of scores respectively associated with the plurality of data sources. The operations for calculating the scores may be similar to those described above with reference to FIG. 1.

At 340, method 300 involves generating a training dataset for training a LLM based on the plurality of data items and the plurality of scores. In some implementations, generating the training dataset involves selecting one or more data sources associated with scores that satisfy a threshold and sampling data items from the selected data sources based on one or more sampling weights that correlate to the scores of the one or more data sources.

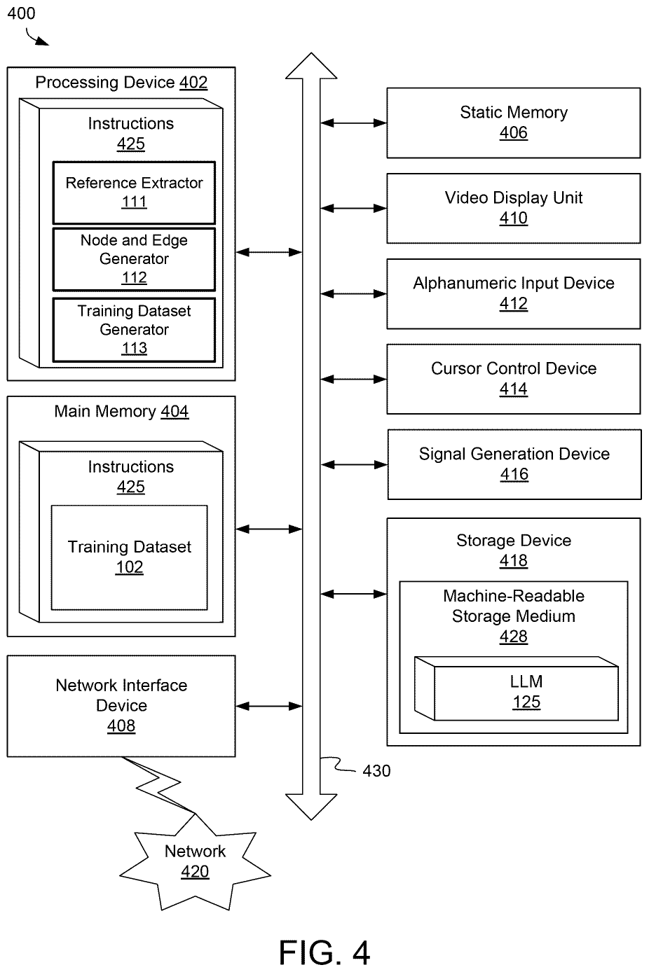

FIG. 4 is a block diagram of an example computing device 400 that may perform one or more of the operations described herein, in accordance with some implementations. For example, computing device 400 may be implemented as, e.g., computing device 110A. Computing device 400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

Computing device 400 may include a processing device (e.g., a general-purpose processor) 402, a main memory 404 (e.g., synchronous dynamic random access memory (DRAM), read-only memory (ROM)), a static memory 406 (e.g., flash memory), and a data storage device 418, which may communicate with each other via a bus 430.

Processing device 402 may be provided by one or more general-purpose processing devices, such as a microprocessor, central processing unit, or the like. For example, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may also include one or more special-purpose processing devices such as an application specific integrated circuit (ASIC), a field programmable gate array (FPGA), a digital signal processor (DSP), network processor, or the like. Processing device 402 may be configured to execute the operations described herein, in accordance with one or more aspects of the present disclosure, for performing the operations and steps discussed herein.

Computing device 400 may further include a network interface device 408, which may communicate with a network 420. Computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and/or a signal generation device 416 (e.g., a speaker). In some implementations, video display unit 410, alphanumeric input device 412, and cursor control device 414 may be combined into a single component or device (e.g., an LCD touch screen).

Data storage device 418 may include a computer-readable storage medium 428 on which may be stored source code and/or configurations of a LLM, e.g., LLM 125. LLM 125 may be trained according to instructions 425, which may reside, completely or at least partially, within main memory 404 and/or within processing device 402. For example, processing device may obtain computer-readable media storing instructions 425, which, when executed, perform functions of reference extractor 111, node and edge generator 112, and training dataset generator 113. Also, main memory 404 may store instructions 425 for generating and storing training dataset 102. Instructions 425 may be transmitted or received over a network 420 via network interface device 408.

While the term “computer-readable storage medium” is described as a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “receiving,” “configuring,” “identifying,” “transmitting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular implementations only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware —-for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the embodiments and their practical applications, to thereby enable others skilled in the art to best utilize the implementations and various modifications as may be suited to the particular use contemplated. Accordingly, the present implementations are to be considered as illustrative and not restrictive, and the invention is not to be limited to the details given herein, but may be modified within the scope and equivalents of the appended claims.

1. A method comprising:
extracting a plurality of references from a plurality of data items received from a plurality of data sources;
generating, by a processing device, a data structure comprising a plurality of nodes and a plurality of edges, wherein the plurality of nodes are respectively associated with the plurality of data sources, and the plurality of edges are respectively associated with the plurality of references;
determining, based on the data structure, a plurality of scores respectively associated with the plurality of data sources, wherein, for each node, determining the plurality of scores comprises:
counting a number of edges in connection with the node;
determining reliability information of the data source associated with the node;
computing a weighted sum based on the number of edges and the reliability information; and
normalizing the weight sum; and
generating a training dataset for training a large language model (LLM) based on the plurality of data items and the plurality of scores, wherein data items from a high quality data source has greater influence than data items from a low quality data source on the training dataset.

2. The method of claim 1, wherein extracting the plurality of references comprises:
detecting a data media format of the plurality of data items;
selecting a media conversion application based on the data media format, wherein the media conversion application is to convert a data item from the data media format to another format; and
deploying the media conversion application to the plurality of data items.

3. The method of claim 1, wherein the LLM model corresponds to a generative artificial intelligence (AI) application for a semantic topic, the method further comprising:
creating a link according to the semantic topic to indicate a relationship between two data sources.

4. The method of claim 1, further comprising:
parsing an identifier of the node associated with the node to determine the reliability information, wherein the reliability information comprises at least one of: an authority of the data source, a relevance of the data source to an artificial intelligence (AI) application, or a recency of content of data items from the data source.

5. The method of claim 1, wherein generating the training dataset comprises:
selecting, from the plurality of data sources, one or more data sources associated with scores that satisfy a threshold; and
sampling data items from the one or more data sources based on one or more sampling weights that correlate to the scores of the one or more data sources.

6. The method of claim 3, further comprising:
selecting, from a pool of data sources, the plurality of data sources that are relevant to the semantic topic.

7. The method of claim 3, further comprising:
receiving, from a client device, a query about the semantic topic; and
deploying the generative AI application to generate a response to the query based on the LLM model.

8. A system comprising:
a memory; and
a processing device operatively couple to the memory, the processing device to:
extract a plurality of references from a plurality of data items received from a plurality of data sources;
generate, by the processing device, a data structure comprising a plurality of nodes and a plurality of edges, wherein the plurality of nodes are respectively associated with the plurality of data sources, and the plurality of edges are respectively associated with the plurality of references;
determine, based on the data structure, a plurality of scores respectively associated with the plurality of data sources, wherein, to determine the plurality of scores, the processing device is to, for each node:
count a number of edges in connection with the node;
determine reliability information of the data source associated with the node;
compute a weighted sum based on the number of edges and the reliability information; and
normalize the weight sum; and
generate a training dataset for training a large language model (LLM) based on the plurality of data items and the plurality of scores, wherein data items from a high quality data source has greater influence than data items from a low quality data source on the training dataset.

9. The system of claim 8, wherein, to extract the plurality of references, the processing device is to:
detect a data media format of the plurality of data items;
select a media conversion application based on the data media format, wherein the media conversion application is to convert a data item from the data media format to another format; and
deploy the media conversion application to the plurality of data items.

10. The system of claim 8, wherein the LLM model corresponds to a generative AI application for a semantic topic, and the processing device is further to:
create a link according to the semantic topic to indicate a relationship between two data sources.

11. The system of claim 8, wherein the processing device is to, for each node:
parse an identifier of the node associated with the node to determine the reliability information, wherein the reliability information comprises at least one of: an authority of the data source, a relevance of the data source to an artificial intelligence (AI) application, or a recency of content of data items from the data source.

12. The system of claim 8, wherein, to generate the training dataset, the processing device is to:
select, from the plurality of data sources, one or more data sources associated with scores that satisfy a threshold; and
sample data items from the one or more data sources based on one or more sampling weights that correlate to the scores of the one or more data sources.

13. The system of claim 10, wherein the processing device is further to select, from a pool of data sources, the plurality of data sources that are relevant to the semantic topic.

14. The system of claim 10, wherein the processing device is further to:
receive, from a client device, a query about the semantic topic; and
deploy the generative AI application to generate a response to the query based on the LLM model.

15. A non-transitory computer-readable medium storing instructions that, when executed by a processing device, cause the processing device to:
extract a plurality of references from a plurality of data items received from a plurality of data sources;
generate, by the processing device, a data structure comprising a plurality of nodes and a plurality of edges, wherein the plurality of nodes are respectively associated with the plurality of data sources, and the plurality of edges are respectively associated with the plurality of references;
determine, based on the data structure, a plurality of scores respectively associated with the plurality of data sources, wherein, to determine the plurality of scores, the instructions cause the processing device to, for each node:
count a number of edges in connection with the node;
determine reliability information of the data source associated with the node;
compute a weighted sum based on the number of edges and the reliability information; and
normalize the weight sum; and
generate a training dataset for training a large language model (LLM) based on the plurality of data items and the plurality of scores, wherein data items from a high quality data source has greater influence than data items from a low quality data source on the training dataset.

16. The non-transitory computer-readable medium of claim 15, wherein, to extract the plurality of references, the instructions cause the processing device to:
detect a data media format of the plurality of data items;
select a media conversion application based on the data media format, wherein the media conversion application is to convert a data item from the data media format to a semantic reference format; and
deploy the media conversion application to the plurality of data items.

17. The non-transitory computer-readable medium of claim 15, wherein the LLM model corresponds to a generative artificial intelligence (AI) application for a semantic topic, and the processing device is further to:
create a link according to the semantic topic to indicate a relationship between two data sources.

18. The non-transitory computer-readable medium of claim 15, wherein the instructions cause the processing device to, for each node:
parse an identifier of the node associated with the node to determine the reliability information, wherein the reliability information comprises at least one of: an authority of the data source, a relevance of the data source to an artificial intelligence (AI) application, or a recency of content of data items from the data source.

19. The non-transitory computer-readable medium of claim 15, wherein, to generate the training dataset, the instructions cause the processing device to:
select, from the plurality of data sources, one or more data sources associated with scores that satisfy a threshold; and
sample data items from the one or more data sources based on one or more sampling weights that correlate to the scores of the one or more data sources.

20. The non-transitory computer-readable medium of claim 17, wherein the instructions further cause the processing device to select, from a pool of data sources, the plurality of data sources that are relevant to the semantic topic.
